(19) United States
(12) Patent Application Publication
(10) Pub. No.: US 2015/0248206 A1
(43) Pub. Date: Sep. 3, 2015

(54) WORD PROCESSING METHOD AND DEVICE FOR SMART DEVICE WITH TOUCH SCREEN

(71) Applicant: SHENZHEN TCL NEW TECHNOLOGY CO., LTD, Shenzhen, Guangdong (CN)

(72) Inventors: Yun Liu, Shenzhen (CN); Zhufeng Li, Shenzhen (CN)

(21) Appl. No.: 14/431,313

(22) PCT Filed: Sep. 4, 2013
(86) PCT No.: PCT/CN2013/082946

§ 371 Date: Mar. 26, 2015

(30) Foreign Application Priority Data
Sep. 27, 2012 (CN) 201210370025.1

(51) Int. Cl. G06F 3/0488; G06F 3/0484; G06F 3/041; G06F 3/0482

(52) U.S. Cl. CPC G06F 3/0488; G06F 3/0482; G06F 3/04842; G06F 3/041; G06F 2203/04104

(57) ABSTRACT

The present disclosure provides a wording processing method for smart device with touch screen, including following steps: when it is detected that the number of touch points on a touch screen is two, storing initial coordinates of the two touch points; when it is detected that two touch points disappear, determining whether a distance between final coordinates of the two touch points is less than a preset threshold; and when the distance between the final coordinates of the two touch points is less than the preset threshold, triggering a word processing prompt menu. When performing the word processing operation, the word processing device of the present disclosure analyzes the user's gesture by using the multi-point touch technology and obtains the purpose of the word editing operation from user, which facilitates the word processing operation and provide a more rapid response.

### BACKGROUND

1. Technical Field

The present disclosure relates to smart technologies, and particularly, to a word processing method and a word processing device for a smart device with touch screen.

2. Description of Related Art

As touch screens are more and more widely used in smart devices such as mobile phones with touch screen and tablet computers, many functions, for example, word editing functions of personal computers can be realized through the touch screens. At present, compared with the operations on personal computers, most text editing operations on the touch screen, for example, operations of copying and pasting the text on the touch screen are less inconvenient, which require specific instructions from the user before next reactions are performed. That is, the smart devices cannot rapidly understand the purpose of an operation from the user and the response efficiency is low.

### SUMMARY

One object of the present disclosure is to provide a word processing method and a word processing device for smart device with touch screen which facilitates the operation and provides a more rapid response.

A wording processing method for smart device with touch screen, includes following steps:
when it is detected that the number of touch points on a touch screen is two, storing initial coordinates of the two touch points;
when it is detected that two touch points disappear, determining whether a distance between final coordinates of the two touch points is less than a preset threshold; and
when the distance between the final coordinates of the two touch points is less than the preset threshold, triggering a word processing prompt menu.

Preferably, the word processing method of claim 1, wherein the preset threshold is equal to eighty percent of a distance between two initial coordinates of the two touch points.

Preferably, the word processing prompt menu includes a copy/cut selection box; after the step of when the distance between the final coordinates of the two touch points is less than the preset threshold, triggering a word processing prompt menu, the word processing method further includes:
receiving a copy instruction or a cut instruction selected by user, copying or cutting words located between the initial coordinates of the two touch points.

Preferably, after the step of receiving a copy instruction or a cut instruction selected by user, copying or cutting words located between the initial coordinates of the two touch points, the word processing method further includes:
when a single touch point is detected on a word editing area, storing coordinates of the single touch point and displaying a paste selection box;
receiving a paste instruction selected by user, pasting the words located between the initial coordinates of the two touch points to a position corresponding to the coordinates of the single touch point.

Preferably, after the step of when it is detected that the number of touch points on a touch screen is two, storing initial coordinates of the two touch points, the word processing method includes:
when the distance between the two touch points is increased, determining that the operation is canceled and clearing the stored initial coordinates of the two touch points.

The present disclosure also provides another word processing method for smart device with touch screen, including following steps:
when it is detected that the number of touch points on a touch screen is two, storing initial coordinates of the two touch points;
when a distance between the two touch points is reduced, moving words located between the initial coordinates of the two touch points towards a middle position between the two touch points;
when a distance between the two touch points is increased, separating the words located between the initial coordinates of the two touch points into the two touch points respectively;
when the two touch points disappear, determining whether a distance between final coordinates of the two touch points is less than a preset threshold; and
when the distance between the final coordinates of the two touch points is less than the preset threshold, triggering a word processing prompt menu.

Preferably, after the step of when it is detected that the number of touch points on a touch screen is two, storing initial coordinates of the two touch points, the word processing method further includes:
starting a timer and detecting a distance between the two touch points according to a detection frequency preset in the timer;
when a currently-detected distance is less than a previously-detected distance, determining that the distance between the two touch points is reduced; and
when the currently-detected distance is greater than the previously-detected distance, determining that the distance between the two touch points is increased.

Preferably, the preset threshold is equal to eighty percent of a distance between the initial coordinates of the two touch points.

Preferably, the word processing prompt menu includes a copy/cut selection box; after the step when the distance between the final coordinates of the two touch points is less than the preset threshold, triggering a word processing prompt menu, the word processing method includes:
receiving a copy instruction or a cut instruction selected by user, copying or cutting words located between the initial coordinates of the two touch points.

Preferably, after the step of receiving a copy instruction or a cut instruction selected by user, copying or cutting words located between the initial coordinates of the two touch points, the word processing method further includes:
when a single touch point is detected on a word editing area, storing coordinates of the single touch point and displaying a paste selection box; and
receiving a paste instruction selected by user, pasting the words located between the initial coordinates of the two touch points to a position corresponding to coordinates of the single touch point.

Preferably, after the step of when it is detected that the number of touch points on a touch screen is two, storing initial coordinates of the two touch points, the word processing method further includes:
when the distance between the two touch points is increased, determining that the operation is canceled by user and clearing the stored initial coordinates of the two touch points.

The present disclosure further provides a word processing device for smart device with touch screen, including:
a first touch point detecting module, configured to store initial coordinates of two touch points when it is detected that the number of the touch points on a touch screen is two;
a determining module, configured to determine whether a distance between final coordinates of the two touch points is less than a preset threshold; and
a menu triggering module, configured to trigger a word processing prompt menu when the distance between final coordinates of the two touch points is less than the preset threshold.

Preferably, the preset threshold is equal to eighty percent of a distance between the initial coordinates of the two touch points.

Preferably, the word processing prompt menu includes a copy/cut selection box; the word processing device includes a first instruction processing module configured to receive a copy instruction or a cut instruction selected by user and copy or cut words located between the initial coordinates of the two touch points.

Preferably, the word processing device further includes:
a second touch point detecting module, configured to store coordinates of a single touch point when the single touch point is detected on a word editing area and display a paste selection box; and
a second instruction processing module, configured to receive a paste instruction selected by user and paste the words located between the initial coordinates of the two touch points to a position corresponding to the coordinates of the single touch point.

Preferably, the word processing device further includes a clearing module configured to determine that the operation is canceled by user when a distance between the two touch points is increased and clear the stored initial coordinates of the two touch points.

Preferably, the word processing device further includes a word scaling module configured to, when the distance between the two touch points is reduced, move words located between the initial coordinates of the two touch points towards a middle position between the two touch points; and when the distance between the two touch points is increased, separate the words located between the two touch points into the two touch points respectively.

Preferably, the word processing module further includes a distance detecting module and a distance determining module; the distance detecting module is configured to start a timer and detect the distance between the two touch points according to a detection frequency preset in the timer; the distance determining module is configured to determine that the distance between the two touch points is reduced when a currently-detected distance is less than a previously-detected distance, and to determine that the distance between the two touch points is increased when the currently-detected distance is greater than the previously-detected distance.

According to the embodiments, when performing the word processing operations, the smart device analyzes the user's gesture by using the multi-point touch technology and obtains the purpose of the word editing operation from the user according to the situation of the touch points, which facilitates the word processing operation and provides a more rapid response.

### DESCRIPTION OF THE DRAWINGS

FIG. 1 is a flow chart of a word processing method for smart device with touch screen in accordance with a first embodiment of the present disclosure;

FIG. 2 is a flow chart of a word processing method for smart device with touch screen in accordance with a second embodiment of the present disclosure;

FIG. 3 is a flow chart of a word processing method for smart device with touch screen in accordance with a third embodiment of the present disclosure;

FIG. 4 is a flow chart of a word processing method for smart device with touch screen in accordance with a fourth embodiment of the present disclosure;

FIG. 5 is a flow chart of a word processing method for smart device with touch screen in accordance with a fifth embodiment of the present disclosure;

FIG. 6 is a flow chart of a step of determining a scaling situation of a distance between two touch points in the word processing method;

FIG. 7 is a schematic view of a word processing device for smart device with touch screen in accordance with a first embodiment of the present disclosure;

FIG. 8 is a schematic view of a word processing device for smart device with touch screen in accordance with a second embodiment of the present disclosure;

FIG. 9 is a schematic view of a word processing device for smart device with touch screen in accordance with a third embodiment of the present disclosure;

FIG. 10 is a schematic view of a word processing device for smart device with touch screen in accordance with a fourth embodiment of the present disclosure;

FIG. 11 is a schematic view of a word processing device for smart device with touch screen in accordance with a fifth embodiment of the present disclosure; and

FIG. 12 is a schematic view of a word processing device for smart device with touch screen in accordance with a sixth embodiment of the present disclosure.

The realization of the object, features, and advantages of the present disclosure are given in further detail in combination with the embodiments with reference to the accompanying drawings.

### DETAILED DESCRIPTION

It should be understood that the embodiments described herein are only used to explain the present disclosure rather than to limit the present disclosure.

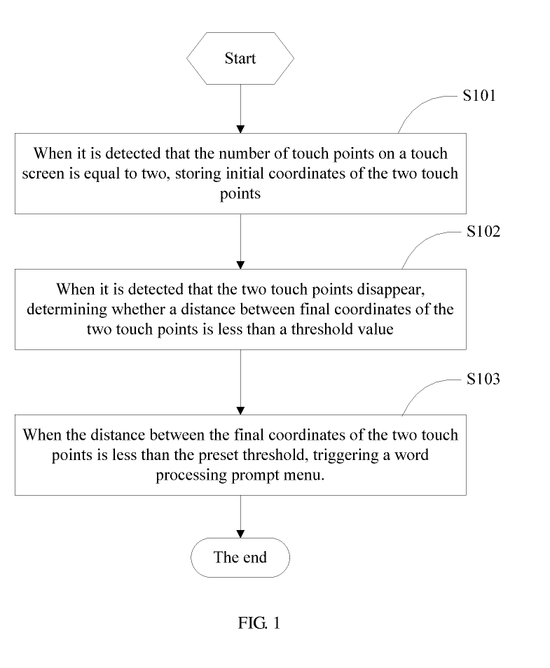

Referring to FIG. 1, which is a flow chart of a word processing method for smart device with touch screen in accordance with a first embodiment of the present disclosure, the word processing method includes steps as follows.

Step S101, when it is detected that the number of touch points on a touch screen is equal to two, storing initial coordinates of the two touch points.

In some embodiments, the touch screen of the smart device can support multi-point touch technology. When a user puts two fingers on the touch screen at the same time, the smart device detects the two touch points and stores the initial coordinates of the two touch points. After that, the smart device determines that words located between the two initial coordinates are needed to be processed.

Step S102, when it is detected that the two touch points disappear, determining whether a distance between final coordinates of the two touch points is less than a threshold value.

When the two fingers get closer, the smart device detects that the distance between the two touch points is reduced; when the fingers leave the touch screen, the distance between the two touch points is less than the preset threshold, the smart device determines that the user needs to perform the word processing operation and pops up a word processing prompt menu allowing the user to choose the corresponding option. Supposed that the distance between the initial coordinates of the two touch points is D(0), the threshold can be set to be a percentage of the initial distance D(0), for example, eighty percent of the initial distance D(0); when D(x)<80%* D(0), the smart device determines that the user needs to copy or cut the words.

The threshold also can be preset to be within a range, for example, from sixty percent of D(0) to eighty percent of D(0); when 60%* D(0)<D(x)<80%* D(0), the smart device determines that the user wants to copy or cut the words.

The threshold also can be preset to be a fixed value, for example, the fixed value can be equal to the width of one character. When D(x) is less than the width of one character, the smart device determines that the user wants to process the words.

Step S103, when the distance between the final coordinates of the two touch points is less than the preset threshold, triggering a word processing prompt menu.

The word processing prompt menu can include a copy/cut selection box, a search selection box, a word storing selection box, a word scaling selection box, such that the smart device can perform corresponding word processing operation according to the selection of the user.

According to the embodiment, when the smart device performs the word processing operation, the word processing method of the embodiment analyzes the user's gesture by using the multi-point touch technology and obtains the purpose of the word editing operation from the user according to the situation of the touch points, which facilitates the word processing operation and provides a more rapid response.

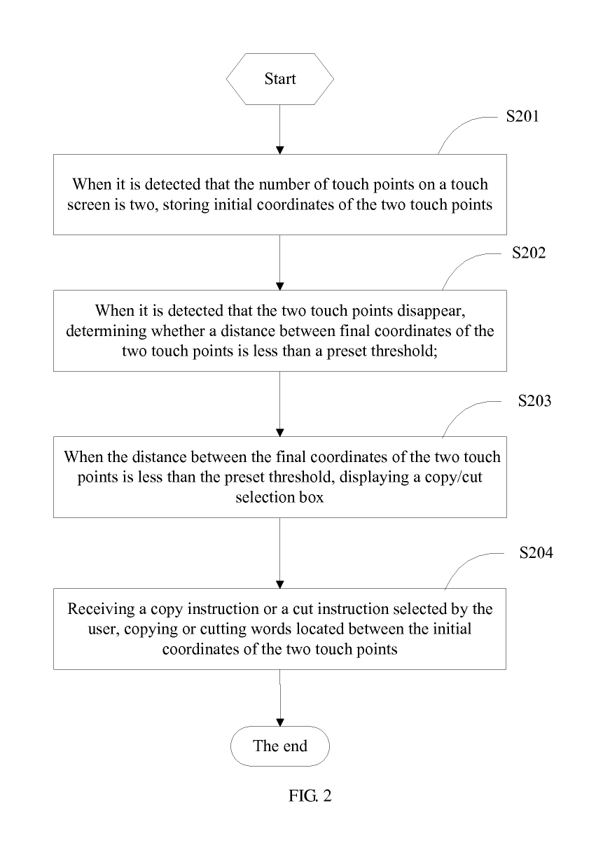

FIG. 2 is a flow chart of a word processing method for smart device with touch screen in accordance with a second embodiment. Compared with the method of the first embodiment, the word processing method of the second embodiment is based on copy/cut operations from the user, and correspondingly, the word processing prompt menu includes a copy/cut selection box. The word processing method of the second embodiment includes steps as follows:

step S201, when it is detected that the number of touch points on a touch screen is two, storing initial coordinates of the two touch points;

step S202, when it is detected that the two touch points disappear, determining whether a distance between final coordinates of the two touch points is less than a preset threshold;

step S203, when the distance between the final coordinates of the two touch points is less than the preset threshold, displaying a copy/cut selection box; and step S204, receiving a copy instruction or a cut instruction selected by the user, copying or cutting words located between the initial coordinates of the two touch points.

The copy/cut selection box can include a copy option, a cut option, and a cancel option. When the user selects the copy option, the smart device stores the words located between the initial coordinates of the two touch points to the clipboard of the system; when the user selects the cut option, the smart device deletes the words located between the initial coordinates of the two touch points and stores the words to the clipboard of the system; when the user selects the cancel option, the smart device performs no operations.

According to the embodiment, when the smart device is used to perform the copy/cut operation, the word processing method of the embodiment analyzes the user's gesture by using the multi-point touch technology and obtains the purpose of the word editing operation from the user according to the situation of the touch points on the touch screen, which facilitates the copy/cut operation and provides a more rapid response.

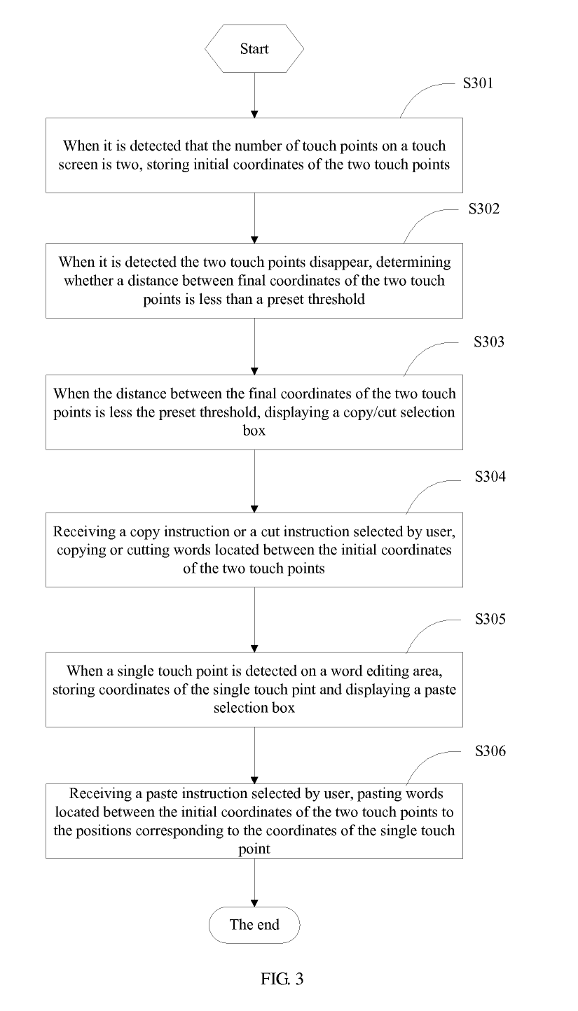

Referring to FIG. 3, which is a flow chart of a word processing method for smart device with touch screen in accordance with a third embodiment, based on the second embodiment, the word processing method of the third embodiment includes steps as follows:
step S301, when it is detected that the number of touch points on a touch screen is two, storing initial coordinates of the two touch points;
step S302, when it is detected the two touch points disappear, determining whether a distance between final coordinates of the two touch points is less than a preset threshold;
step S303, when the distance between the final coordinates of the two touch points is less the preset threshold, displaying a copy/cut selection box;
step S304, receiving a copy instruction or a cut instruction selected by the user, copying or cutting words located between the initial coordinates of the two touch points;
step S305, when a single touch point is detected on a word editing area, storing coordinates of the single touch pint and displaying a paste selection box; and
step S306, receiving a paste instruction selected by the user, pasting words located between the initial coordinates of the two touch points to the position corresponding to the coordinates of the single touch point.

In the step S305, the smart device generates a single touch point when detecting that one finger of the user enters the word editing area and then pops up the paste selection box.

The paste selection box includes a paste option, a cancel option, and an ending option. Correspondingly, following operations are performed: when the user selects the paste option, pasting the words which are previously copied or cut to the position corresponding to the coordinates of the single touch point; when the user selects the cancel option, no operations are performed; or, when the user selects the ending option, clearing the stored words and the coordinates of the touch points. By finger touch point operations, the word processing method of the embodiment provides a much simpler paste operation on the smart device.

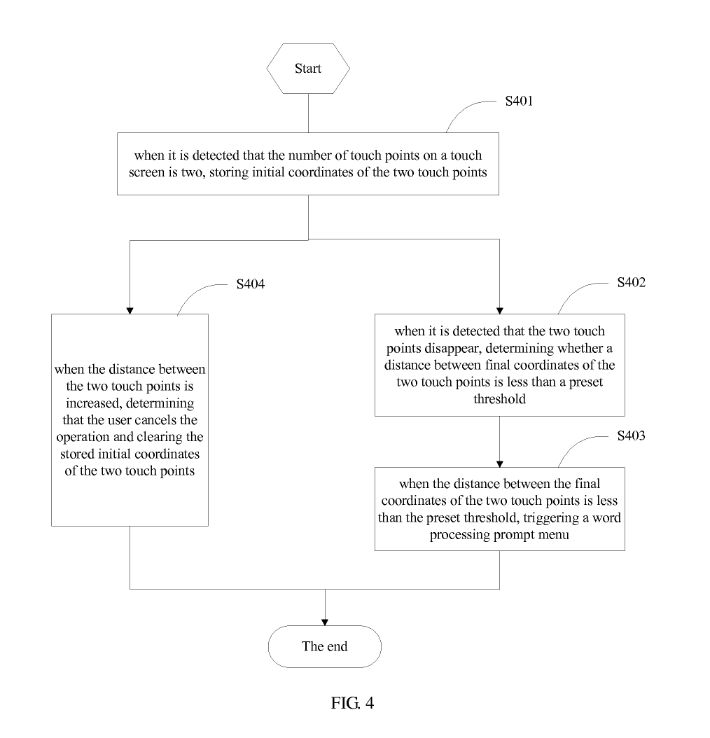

Referring to FIG. 4, which is a flow chart of a word processing method for smart device with touch screen in accordance with a fourth embodiment, based on the first embodiment, the word processing method of the embodiment includes steps as follows:
step S401, when it is detected that the number of touch points on a touch screen is two, storing initial coordinates of the two touch points;
step S402, when it is detected that the two touch points disappear, determining whether a distance between final coordinates of the two touch points is less than a preset threshold;
step S403, when the distance between the final coordinates of the two touch points is less than the preset threshold, triggering a word processing prompt menu; and
step S404, when the distance between the two touch points is increased, determining that the user cancels the operation and clearing the stored initial coordinates of the two touch points.

In the embodiment, when the two fingers get closer, it is considered that the selected word range is not the desired one. When the two fingers move apart, the smart device determines that the user cancels the operation and clears the initial coordinates of the two touch points when detecting that the distance between the two touch points is increased. By getting the touch points closer or moving the touch points apart, the word selection can be easily realized or canceled, facilitating the operation and providing a more rapid response speed.

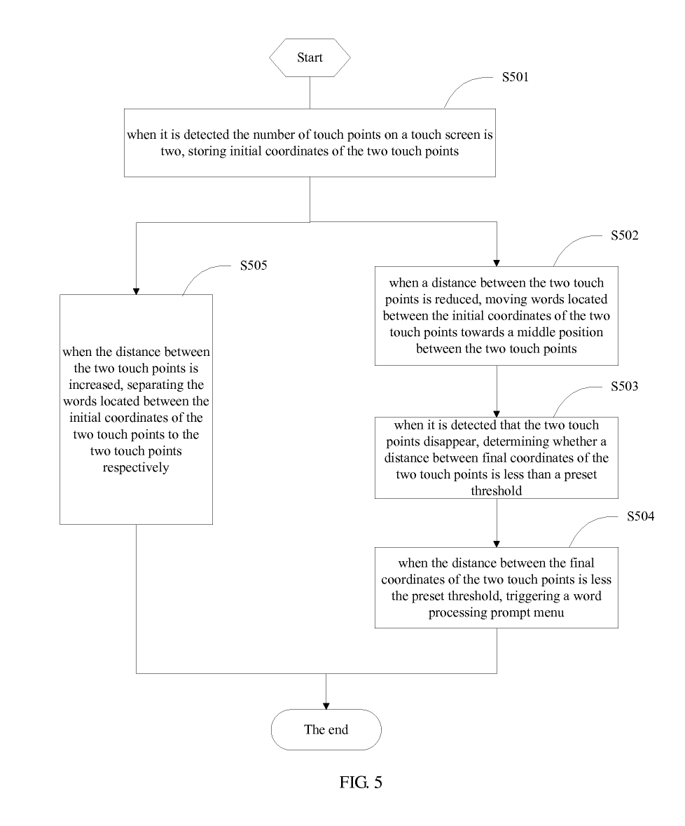

Referring to FIG. 5, which is a flow chart of a word processing method for smart device with touch screen in accordance with a fifth embodiment, based on the first embodiment, the word processing method includes steps as follows:
step S501, when it is detected the number of touch points on a touch screen is two, storing initial coordinates of the two touch points;
step S502, when a distance between the two touch points is reduced, moving words located between the initial coordinates of the two touch points towards a middle position between the two touch points;

step S503, when it is detected that the two touch points disappear, determining whether a distance between final coordinates of the two touch points is less than a preset threshold;

step S504, when the distance between the final coordinates of the two touch points is less the preset threshold, triggering a word processing prompt menu; and
step S505, when the distance between the two touch points is increased, separating the words located between the initial coordinates of the two touch points to the two touch points respectively.

In step S502, when the two fingers get closer, the words located between the two touch points move towards the middle position, providing a visual effect that the words are pinched by the fingers and thus improving the user' visual experience.

When the touch points move apart, the words located between the two touch points correspondingly move apart, providing a visual effect that the words are put down by the fingers and thus improving the user's visual experience.

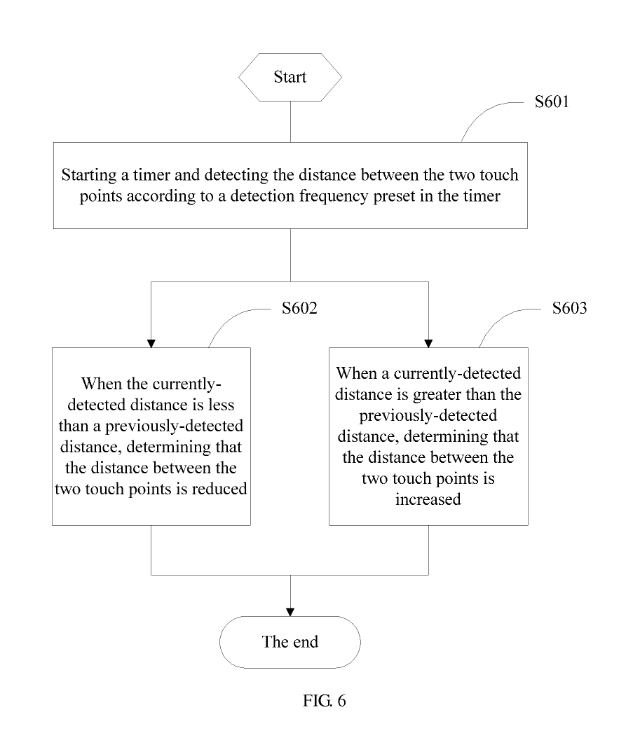

Referring to FIG. 6, which is a flow chart of a step of determining the scaling situation of the distance between the touch points in the word processing method for smart device with touch screen, the step includes steps as follows.

Step S601, starting a timer and detecting the distance between the two touch points according to a detection frequency preset in the timer.

The smart device regularly detects the coordinates of the touch points and calculates the distance between the touch points, for example, the smart device performs the detection once per 20 milliseconds.

Step S602, when a currently-detected distance is less than a previously-detected distance, determining that the distance between the two touch points is reduced.

Supposed that the currently-detected distance is D(x) and the previously-detected distance is D(x−1), when D(x)<D(x−1), it indicates that the distance between the two touch points is reduced.

Step S603, when the currently-detected distance is greater than the previously-detected distance, determining that the distance between the two touch points is increased.

When D(x)>D(x−1), it indicates that the distance between the two touch points is reduced.

According to the embodiment, the word processing method analyzes the user's gesture by using multi-point touch technology and obtains the purpose of the word editing operation from the user by detecting the distance between the two touch points in real time, which facilitates the copy/cut operation and provides a more rapid response.

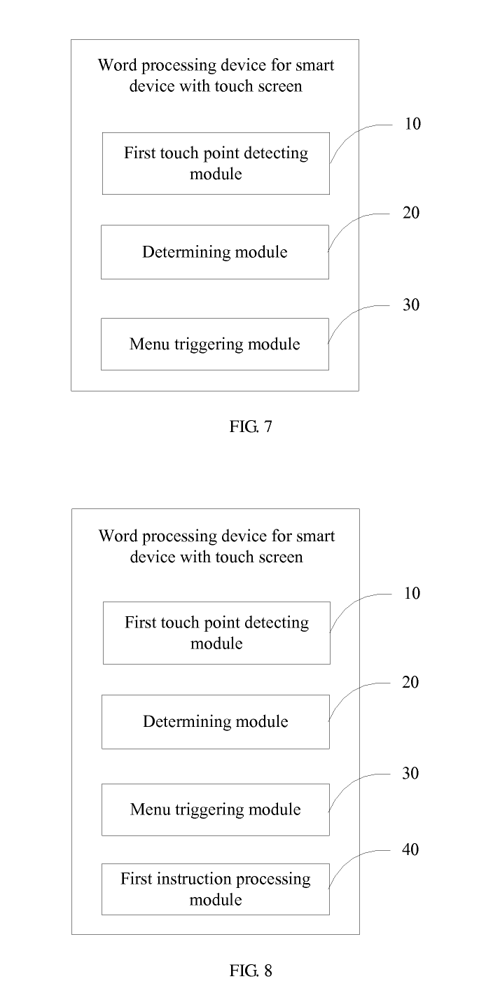

Referring to FIG. 7, which is a schematic view of a word processing device for smart device with touch screen in accordance with a first embodiment, the word processing device includes a first touch point detecting module 10, a determining module 20, and a menu triggering module 30.

The first touch point detecting module 10 is configured to store initial coordinates of two touch points when it is detected that the number of the touch points is equal to two.

The determining module 20 is configured to determine whether a distance between final coordinates of the two touch points is less than a preset threshold when it is detected that the two touch point disappear.

The menu triggering module 30 is configured to trigger a word processing prompt menu when the distance between the final coordinates of the two touch points is less than the preset threshold.

The touch screen of the smart device supports multi-point touch technology. When the user puts two fingers on the touch screen, the smart device detects two touch points and stores the initial coordinates of the two touch points. At this time, the smart device determines that the words located between the initial coordinates of the two touch points are needed to be processed. When the user gets the two fingers closer, the smart device detects that the distance between the two touch points is reduced; when the user moves the fingers away from the touch screen, the distance between the two touch points is less than the preset threshold, correspondingly, the smart device determines that the user wants to perform the word processing operation and pops up the word processing prompt menu allowing the user to select the corresponding option. Supposed that the distance between the initial coordinates of the two touch points is D(0), the threshold can be set to be a percentage of the initial distance D(0), for example, eighty percent of the initial distance D(0); when D(x)<80%* D(0), the smart device determines that the user needs to copy or cut the words.

The threshold also can be preset to be within a range, for example, from sixty percent of D(0) to eighty percent of D(0); when 60%* D(0) <D(x)<80%* D(0), the smart device determines that the user wants to copy or cut the words.

The threshold also can be preset to be a fixed value, for example, the fixed value can be equal to the width of one character. When D(x) is less than the width of one character, the smart device determines that the user wants to process the words.

The word processing prompt menu can include a copy/cut selection box, a search selection box, a word storing selection box, a word scaling selection box, such that the smart device can perform corresponding word processing operation according to the selection of the user.

According to the embodiment, when performing the word processing operation, the word processing device analyzes the user's gesture by using the multi-point touch technology and obtains the purpose of the word editing operation from the user according to the situation of the touch points, which facilitates the word processing operation and provides a more rapid response.

FIG. 8 is a schematic view of a word processing device for smart device with touch screen in accordance with a second embodiment of the present disclosure. Compared with the device of the first embodiment, the second embodiment is based on copy/cut operations from the user, and correspondingly, the word processing prompt menu includes a copy/cut selection box. The word processing device further includes a first instruction processing module 40. The first instruction processing module 40 is configured to receive a copy instruction or a cut instruction selected by the user and copy or cut the words located between the initial coordinates of the two touch points.

The copy/cut selection box can include a copy option, a cut option, and a cancel option. When the user selects the copy option, the smart device stores words located between the initial coordinates of the two touch points to the clipboard of the system; when the user selects the cut option, the smart device deletes the words located between the initial coordinates of the two touch points and stores the words to the clipboard of the system; when the user selects the cancel option, the smart device performs no operations.

According to the embodiment, when performing the copy/cut operation, the word processing device analyzes the user's gesture by using the multi-point touch technology and obtains the purpose of the word editing operation from the user according to the situation of the touch points on the touch screen, which facilitates the copy/cut operation and provides a more rapid response.

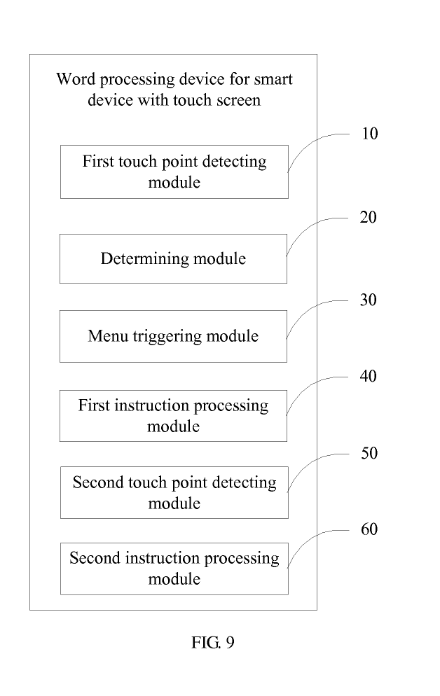

Referring to FIG. 9, which is a schematic view of a word processing device for smart device with touch screen in accordance with a third embodiment of the present disclosure, based on the embodiment shown in FIG. 8, the word processing device of this embodiment further includes a second touch point detecting module 50 and a second instruction processing module 60. The second touch point detecting module 50 is configured to store coordinates of a single touch point when the single touch point is detected on a word editing area and display a paste selection box. The second instruction processing module 60 is configured to receive a paste instruction selected by the user and paste the words located between the initial coordinates of the two touch points to a position corresponding to the coordinates of the single touch point.

The smart device pops up a paste selection box when detecting one finger of the user enters the word editing area. The paste selection box includes a paste option, a cancel option, and an ending option. Following operations are performed according to the selection of the user: when the user selects the paste option, pasting the words which are previously copied or cut to the position corresponding to the coordinates of the single touch point; when the user selects the cancel option, no operations are performed; when the user selects the ending option, clearing the stored words and the coordinates of the touch points. By finger touch point operations, the word processing method of the embodiment provides a much simpler paste operation on the smart device.

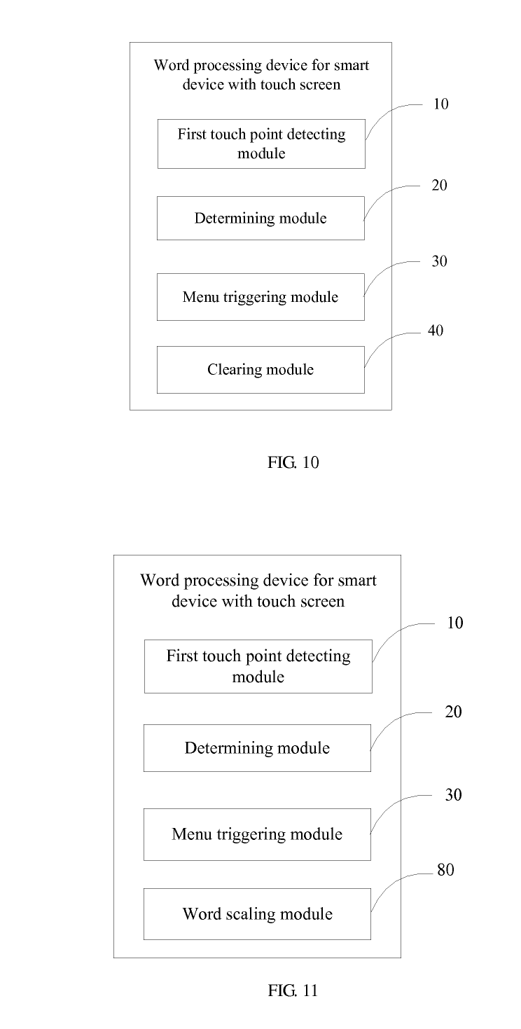

Referring to FIG. 10, which is a schematic view of a word processing device for smart device with touch screen in accordance with a fourth embodiment, based on the word processing device of embodiment shown in FIG. 7, the word processing device further includes a clearing module 70 configured to determine that the operation is canceled by the user and clear the stored initial coordinates of the two touch points when the distance between the two touch points is increased.

In the embodiment, when the user gets his fingers closer, it is considered that the selected word range is not desired; at this time, when the two fingers move apart, the smart device determines that the operation is canceled by the user on detecting that the distance between the two touch points is increased and clears the initial coordinates of the two touch points. By getting the touch points closer or moving the touch points apart, the word processing device of the embodiment can easily realize or cancel word selection, thus, the operation is convenient and the response speed of the system is much more rapid.

FIG. 11 is a schematic view of a word processing device in accordance with a fifth embodiment of the present disclosure, based on the word processing device of the embodiment shown in FIG. 7, the word processing device of the fifth embodiment further includes a word scaling module 80 configured to move the words located between the initial coordinates of the two touch points towards the middle position between the two touch points when the distance between the two touch points is reduced. The word scaling module 80 is also configured to separate the words located between the initial coordinates of the two touch points into the two touch points respectively when the distance between the two touch points is increased.

When the user gets the two fingers closer, the words located between the two touch points move towards the middle position, providing a visual effect that the words are pinched by the fingers and further improving the user's visual experience. When the touch points move apart, the words located between the touch points correspondingly move apart, providing a visual effect that the words are put down by the fingers and thereby improving the user's visual experience.

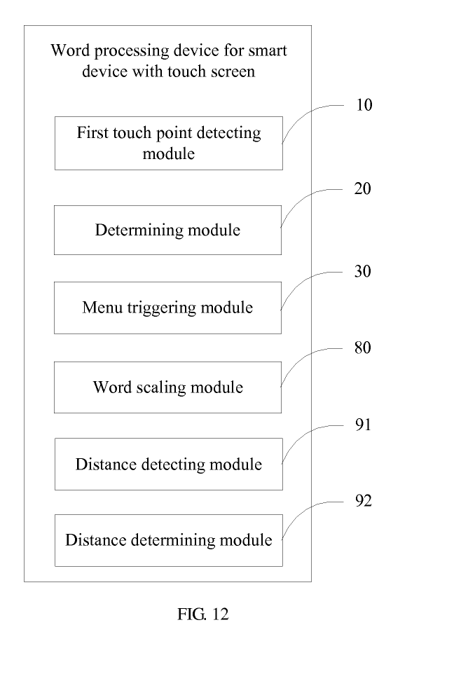

Referring to FIG. 12, which is a schematic view of a word processing device for smart device with touch screen in accordance with a sixth embodiment of the present disclosure, based on the embodiment shown in FIG. 11, the word processing device of this embodiment further includes a distance detecting module 91 and a distance determining module 92.

The distance detecting module 91 is configured to start a timer and detect the distance between the two touch points according to a detection frequency preset in the timer.

The distance determining module 92 is configured to determine that the distance between the two touch points is reduced when the currently-detected distance is less than the previously-detected distance, and to determine that the distance between the two touch points is increased when the currently-detected distance is greater than the previously-detected distance.

According to this embodiment, the mobile terminal detects the coordinates of the touch points on the touch screen and calculates the distance between the two touch points. For example, the smart device detects the coordinates once per 20 milliseconds. Supposed that the currently-detected distance is D(x) and the previously-detected distance is D(x−1), when D(x)<D(x−1), it indicates that the distance between the two touch points is reduced; when D(x)>D(x−1), it indicates that the distance between the two touch points is increased. According to the embodiment, the word processing device analyzes the users' gesture by using the multi-point touch technology and obtains the purpose of the word editing operation from user by detecting the distance between the touch points in real time, which facilitates the word processing operation and provides a more rapid response speed.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A wording processing method for smart device with touch screen, comprising following steps:
when it is detected that the number of touch points on a touch screen is two, storing initial coordinates of the two touch points;
when it is detected that two touch points disappear, determining whether a distance between final coordinates of the two touch points is less than a preset threshold; and
when the distance between the final coordinates of the two touch points is less than the preset threshold, triggering a word processing prompt menu.

2. The word processing method of claim 1, wherein the preset threshold is equal to eighty percent of a distance between two initial coordinates of the two touch points.

3. The word processing method of claim 2, wherein the word processing prompt menu comprises a copy/cut selection box; after the step of when the distance between the final coordinates of the two touch points is less than the preset threshold, triggering a word processing prompt menu, the word processing method further comprises:
receiving a copy instruction or a cut instruction selected by user, copying or cutting words located between the initial coordinates of the two touch points.

4. The word processing method of claim 3, wherein after the step of receiving a copy instruction or a cut instruction selected by user, copying or cutting words located between the initial coordinates of the two touch points, the word processing method further comprises:
when a single touch point is detected on a word editing area, storing coordinates of the single touch point and displaying a paste selection box;
receiving a paste instruction selected by user, pasting the words located between the initial coordinates of the two touch points to a position corresponding to the coordinates of the single touch point.

5. The word processing method of claim 2, wherein after the step of when it is detected that the number of touch points on a touch screen is two, storing initial coordinates of the two touch points, the word processing method comprises:
when the distance between the two touch points is increased, determining that the operation is canceled and clearing the stored initial coordinates of the two touch points.

6. A word processing method for smart device with touch screen, comprising following steps:
when it is detected that the number of touch points on a touch screen is two, storing initial coordinates of the two touch points;
when a distance between the two touch points is reduced, moving words located between the initial coordinates of the two touch points towards a middle position between the two touch points;
when a distance between the two touch points is increased, separating the words located between the initial coordinates of the two touch points into the two touch points respectively;
when the two touch points disappear, determining whether a distance between final coordinates of the two touch points is less than a preset threshold; and
when the distance between the final coordinates of the two touch points is less than the preset threshold, triggering a word processing prompt menu.

7. The word processing method of claim 6, wherein after the step of when it is detected that the number of touch points on a touch screen is two, storing initial coordinates of the two touch points, the word processing method further comprises:
starting a timer and detecting a distance between the two touch points according to a detection frequency preset in the timer;
when a currently-detected distance is less than a previously-detected distance, determining that the distance between the two touch points is reduced; and
when the currently-detected distance is greater than the previously-detected distance, determining that the distance between the two touch points is increased.

8. The word processing method of claim 7, wherein the preset threshold is equal to eighty percent of a distance between the initial coordinates of the two touch points.

9. The word processing method of claim 8, wherein the word processing prompt menu comprises a copy/cut selection box;
after the step when the distance between the final coordinates of the two touch points is less than the preset threshold, triggering a word processing prompt menu, the word processing method comprises:
receiving a copy instruction or a cut instruction selected by user, copying or cutting words located between the initial coordinates of the two touch points.

10. The word processing method of claim 9, wherein after the step of receiving a copy instruction or a cut instruction selected by user, copying or cutting words located between the initial coordinates of the two touch points, the word processing method further comprises:
when a single touch point is detected on a word editing area, storing coordinates of the single touch point and displaying a paste selection box; and
receiving a paste instruction selected by user, pasting the words located between the initial coordinates of the two touch points to a position corresponding to coordinates of the single touch point.

11. The word processing method of claim 8, wherein after the step of when it is detected that the number of touch points on a touch screen is two, storing initial coordinates of the two touch points, the word processing method further comprises:
when the distance between the two touch points is increased, determining that the operation is canceled by user and clearing the stored initial coordinates of the two touch points.

12. A word processing device for smart device with touch screen, comprising:
a first touch point detecting module, configured to store initial coordinates of two touch points when it is detected that the number of the touch points on a touch screen is two;
a determining module, configured to determine whether a distance between final coordinates of the two touch points is less than a preset threshold; and
a menu triggering module, configured to trigger a word processing prompt menu when the distance between final coordinates of the two touch points is less than the preset threshold.

13. The word processing device of claim 12, wherein the preset threshold is equal to eighty percent of a distance between the initial coordinates of the two touch points.

14. The word processing device of claim 13, wherein the word processing prompt menu comprises a copy/cut selection box; the word processing device comprises a first instruction processing module configured to receive a copy instruction or a cut instruction selected by user and copy or cut words located between the initial coordinates of the two touch points.

15. The word processing device of claim 14, further comprising:
a second touch point detecting module, configured to store coordinates of a single touch point when the single touch point is detected on a word editing area and display a paste selection box; and
a second instruction processing module, configured to receive a paste instruction selected by user and paste the words located between the initial coordinates of the two touch points to a position corresponding to the coordinates of the single touch point.

16. The word processing device of claim 13, further comprising a clearing module configured to determine that the operation is canceled by user when a distance between the two touch points is increased and clear the stored initial coordinates of the two touch points.

17. The word processing device of claim 12, further comprising a word scaling module configured to, when the distance between the two touch points is reduced, move words located between the initial coordinates of the two touch points towards a middle position between the two touch points; and when the distance between the two touch points is increased, separate the words located between the two touch points into the two touch points respectively.

18. The word processing device of claim 17, further comprising a distance detecting module and a distance determining module; the distance detecting module is configured to start a timer and detect the distance between the two touch points according to a detection frequency preset in the timer; the distance determining module is configured to determine that the distance between the two touch points is reduced when a currently-detected distance is less than a previously-detected distance, and to determine that the distance between the two touch points is increased when the currently-detected distance is greater than the previously-detected distance.
